(19) United States
(12) Patent Application Publication
(10) Pub. No.: US 2019/0040884 A1
(43) Pub. Date: Feb. 7, 2019

(54) TIE PADLOCK

(71) Applicant: Ningbo Eudemon Child Protective Equipment Co., Ltd., Ningbo (CN)

(72) Inventor: Mingliang HE, NINGBO (CN)

(21) Appl. No.: 15/955,079

(22) Filed: Apr. 17, 2018

(30) Foreign Application Priority Data
Aug. 1, 2017 (CN) 201710647133.1

(51) Int. Cl. F16B 2/08; F16B 2/14

(52) U.S. Cl. CPC F16B 2/08; F16B 2/14

(57) ABSTRACT

The invention discloses a tie padlock, wherein a lock tongue on a tie lock body is inserted into a main lock body, a lock tongue locking mechanism is arranged between the lock tongue and the main lock body, a flexible glue covering layer on the main lock body covers an unlocking mechanism, the tie lock body is internally provided with a tie hole through which a tie passes, and the main lock body is internally provided with a tie locking mechanism. The locked padlock has good locking reliability such that the tie lock body cannot be pulled open with a strong force; and the unlocking mechanism is well hidden such that children cannot easily open the padlock.

### FIELD OF THE INVENTION

The invention relates to a lock and particularly to a tie padlock.

### BACKGROUND OF THE INVENTION

Cabinets are the most common tools for storing articles in our daily life. Doors of cabinets (such as lockers and wardrobes) at home are mostly split-type and partly sliding-type, but regardless of the types, the cabinet doors are basically not equipped with locks or basically not locked so as to facilitate taking articles. However, for families with children, the children will often open cabinet doors to rummage about or take out articles to play with due to their curiosity, which will bring trouble in arrangement to adults and may even cause economic loss.

In order to prevent children from opening cabinet doors at home, some cabinet doors (mainly split-type cabinet doors) are provided with tie padlocks such that two cabinet doors are locked through ties, which can prevent children from opening the cabinet doors, and can also facilitate adults to unlock the tie padlocks when the cabinet doors need to be opened. However, the existing tie padlocks have low reliability such that the padlocks can be opened when pulled with a strong force, or unlocking mechanisms are not well hidden such that children can easily find and open the padlocks.

### SUMMARY OF THE INVENTION

A technical problem to be solved by the invention is to provide a tie padlock which has good locking reliability and a well hidden unlocking mechanism.

To solve the above technical problem, the invention employs the following technical solution: a tie padlock comprises a main lock body and two tie lock bodies oppositely arranged at left and right sides of the main lock body, wherein a lock tongue is fixedly arranged on each of the tie lock bodies and inserted into the main lock body, a lock tongue locking mechanism is arranged between the lock tongue and the main lock body, the main lock body is provided with an unlocking mechanism, a flexible glue covering layer is fixedly arranged on the main lock body and covers the unlocking mechanism, a tie is fixedly arranged on the tie lock body, the tie lock body is internally provided with a penetrating tie hole through which the tie passes, the main lock body is internally provided with a tie locking mechanism, when one lock tongue is disengaged from the main lock body, the tie located on the tie lock body with the lock tongue is unlocked at the same time, and when one lock tongue is locked into the main lock body, the tie located on the tie lock body with the lock tongue is locked at the same time.

Further, the lock tongue locking mechanism includes a lock tongue buckle and a first spring, the lock tongue is integrally arranged on the tie lock body, the lock tongue is internally provided with a lock tongue cavity which is opened at one side, the lock tongue buckle is located in the lock tongue cavity and hinged with the lock tongue, the first spring butts between the bottom of the lock tongue cavity and the lock tongue buckle, a first stop is integrally arranged on the main lock body, and when the lock tongue is inserted into the main lock body, the lock tongue buckle protrudes from the lock tongue cavity and butts against the first stop under the elastic force of the first spring.

Further, the unlocking mechanism includes an unlock button, a middle part of the unlock button is fixedly connected or hinged with the main lock body, and two ends of the unlock button are respectively opposite to the lock tongue buckles at left and right corresponding ends.

Further, the tie locking mechanism includes a second spring and two tie locking blocks, the main lock body is internally provided with a locking block cavity, the locking block cavity is communicated with the tie hole when the lock tongue is inserted into the main lock body, the tie locking block is arranged in the locking block cavity, the second spring butts between the two tie locking blocks, a second stop for preventing the tie locking block from bouncing off the locking block cavity is arranged in the locking block cavity, retaining clamping teeth are integrally arranged at one end of the tie locking block towards the tie, a plurality of retaining slots arrayed along a length direction are integrally arranged at one side of the tie passing through the tie hole towards the tie locking block, and the retaining clamping teeth are clamped into the retaining slots.

Further, two vertically symmetrical lock tongues are integrally arranged on the tie lock body, the tie locking mechanism is located between the upper and lower lock tongues, and unlocking mechanisms corresponding to the upper and lower lock tongues are respectively arranged at upper and lower ends of the main lock body. Such structure allows stable and reliable locking between the tie lock body and the main lock body; and the compact structure allows the entire padlock to be delicate and small. Further, a knob or button is arranged on a front face of the main lock body and serves as a pseudo-switch to confuse children.

Compared with the prior art, the invention has the following advantages: when the lock tongue is inserted and locked into the main lock body, the tie lock body and the main lock body have good locking reliability such that the tie lock body cannot be pulled open with a strong force; since the flexible glue covering layer is fixedly arranged on the main lock body and covers the unlocking mechanism, the unlocking mechanism cannot be found from the outside of the padlock and is well hidden such that children cannot easily open the padlock, which also further improves the locking reliability of the padlock; when the lock tongue is disengaged from the main lock body, the tie located on the tie lock body with the lock tongue is unlocked at the same time such that the padlock is convenient to operate and can be unlocked in one step; the lock tongues at the left and right sides of the main lock body can be operated independently and do not interfere with each other to allow flexible operation; and furthermore, the entire padlock is characterized by a simple structure, lower cost and simple operation.

### BRIEF DESCRIPTION OF THE DRAWINGS

FIG. 1 is a schematic view of a use state of the invention; and

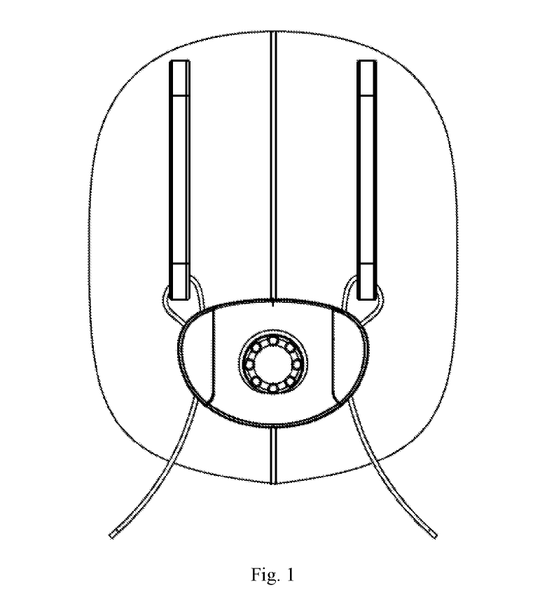

FIG. 2 is a cross-sectional view of the invention; and

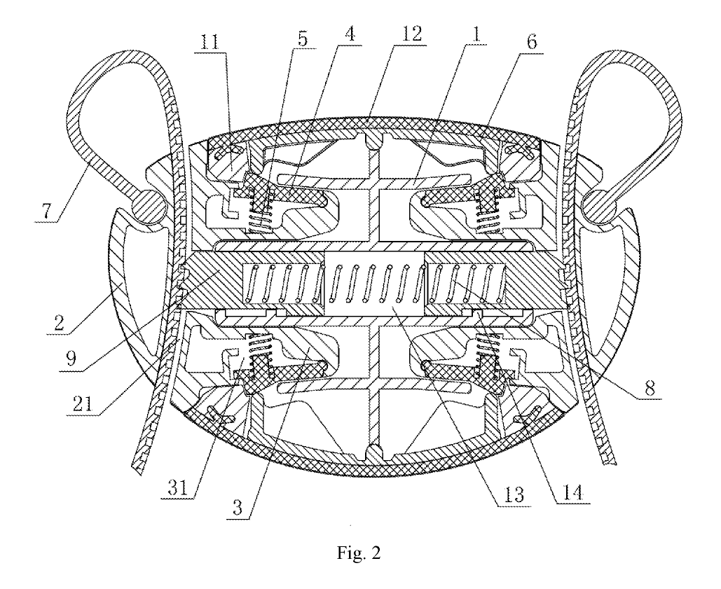

FIG. 3 is a partial schematic exploded view of the invention.

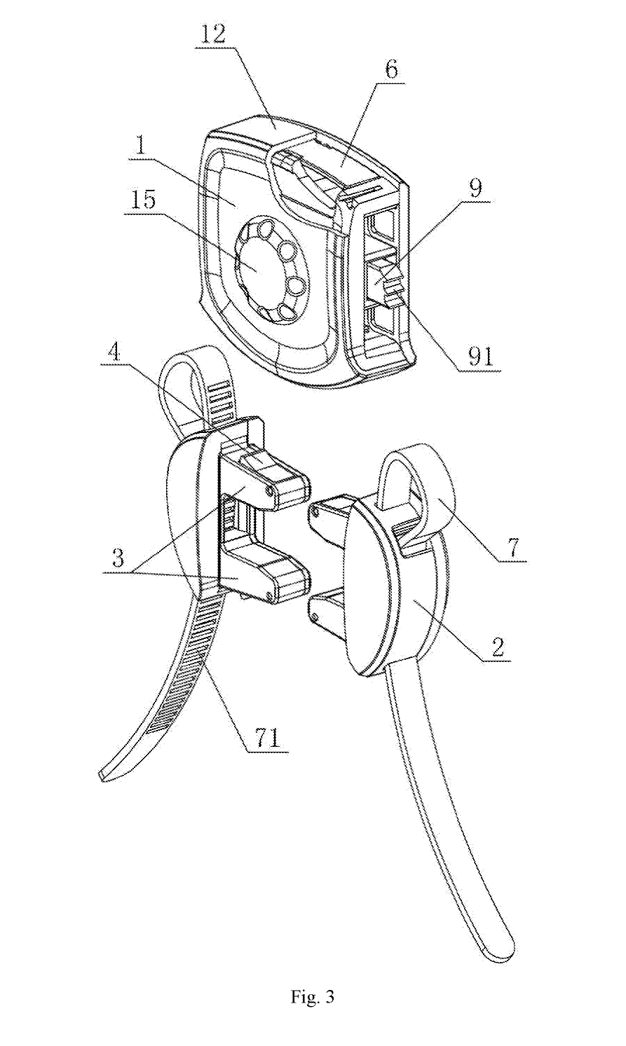

### DETAILED DESCRIPTION OF THE INVENTION

The invention will be further described below in detail with reference to the drawings and embodiments.

As shown, a tie padlock comprises a main lock body 1 and two tie lock bodies 2 oppositely arranged at left and right sides of the main lock body 1. Two vertically symmetrical lock tongues 3 are integrally arranged on the tie lock body 1, the lock tongue 3 is inserted into the main lock body 1, and a lock tongue locking mechanism is arranged between the lock tongue 3 and the main lock body 1. The lock tongue locking mechanism includes a lock tongue buckle 4 and a first spring 5, the lock tongue 3 is internally provided with a lock tongue cavity 31 which is opened at one side, the lock tongue buckle 4 is located in the lock tongue cavity 31 and hinged with the lock tongues 3, the first spring 5 butts between the bottom of the lock tongue cavity 31 and the lock tongue buckle 4, a first stop 11 is integrally arranged on the main lock body 1, and when the lock tongue 3 is inserted into the main lock body 1, the lock tongue buckle 4 protrudes from the lock tongue cavity 31 and butts against the first stop 11 under the elastic force of the first spring 5. Unlocking mechanisms corresponding to the upper and lower lock tongues 3 are respectively arranged at upper and lower ends of the main lock body 1. The unlocking mechanism includes an unlock button 6, a middle part of the unlock button 6 is fixedly connected or hinged with the main lock body 1, and two ends of the unlock button 6 are respectively opposite to the lock tongue buckles 4 at left and right corresponding ends. A flexible glue covering layer 12 is fixedly arranged on the main lock body 1 and covers the unlock button 6, a tie 7 is fixedly arranged on the tie lock body 2, the tie lock body 2 is internally provided with a penetrating tie hole 21 through which the tie 7 passes, and the main lock body 1 is internally provided with a tie locking mechanism which is located between the upper and lower lock tongues 3. The tie locking mechanism includes a second spring 8 and two tie locking blocks 9, the main lock body 1 is internally provided with a locking block cavity 13, the locking block cavity 13 is communicated with the tie hole 21 when the lock tongue 3 is inserted into the main lock body 1, the tie locking block 9 is arranged in the locking block cavity 13, the second spring 8 butts between the two tie locking blocks 9, a second stop 14 for preventing the tie locking block 9 from bouncing off the locking block cavity 13 is arranged in the locking block cavity 13, retaining clamping teeth 91 are integrally arranged at one end of the tie locking block 9 towards the tie 7, a plurality of retaining slots 71 arrayed along a length direction are integrally arranged at one side of the tie 7 passing through the tie hole 21 towards the tie locking block 9, and the retaining clamping teeth 91 are clamped into the retaining slots 71. When one of the lock tongues 3 is disengaged from the main lock body 1, the tie 7 located on the tie lock body 2 with the lock tongue 3 is unlocked at the same time, and when one of the lock tongues 3 is locked into the main lock body 1, the tie 7 located on the tie lock body 2 with the lock tongue 3 is locked at the same time.

In the above embodiment, a knob or button 15 may also be arranged on a front face of the main lock body 1.

In the above embodiment, the locking and unlocking process of the tie padlock is as follows: the tie 7 is passed through the tie hole 21, the lock tongue 3 on the tie lock body 2 is inserted into the main lock body 1, the lock tongue buckle 4 protrudes from the lock tongue cavity 31 and butts against the first stop 11 under the elastic force of the first spring 5 while the tie locking block 9 butts against the tie 7, the tie 7 is pulled down such that the padlock suits a locked position of a split-type cabinet door, the length of the tie 7 is properly adjusted, and then the retaining clamping teeth 91 on the tie locking block 9 are clamped into the retaining slots 71 of the tie 7 to lock the tie 7, thus achieving the locking operation of the padlock; and when the padlock needs to be unlocked, the unlock buttons 6 at the upper and lower ends of the main lock body 1 are pressed simultaneously, one end of the unlock button 6 pushes the lock tongue buckle 4 to avoid the first stop 11, the tie lock body 2 is bounced out of the main lock body 1 under the elastic force of the second spring 8 while the retaining clamping teeth 91 on the tie locking block 9 are also disengaged from the retaining slots 71 of the tie 7, thus the tie 7 is unlocked at the same time and can be pulled out of the tie hole 21.

1. A tie padlock, comprising a main lock body and two tie lock bodies oppositely arranged at left and right sides of the main lock body, a lock tongue being fixedly arranged on each of the tie lock bodies and inserted into the main lock body, a lock tongue locking mechanism being arranged between the lock tongue and the main lock body, the main lock body being provided with an unlocking mechanism, a flexible glue covering layer being fixedly arranged on the main lock body and covering the unlocking mechanism, a tie being fixedly arranged on the tie lock body, the tie lock body being internally provided with a penetrating tie hole through which the tie passes, the main lock body being internally provided with a tie locking mechanism, when one lock tongue is disengaged from the main lock body, the tie located on the tie lock body with the lock tongue being unlocked at the same time, and when one lock tongue is locked into the main lock body, the tie located on the tie lock body with the lock tongue being locked at the same time.

2. The tie padlock according to claim 1, wherein the lock tongue locking mechanism includes a lock tongue buckle and a first spring, the lock tongue is integrally arranged on the tie lock body, the lock tongue is internally provided with a lock tongue cavity which is opened at one side, the lock tongue buckle is located in the lock tongue cavity and hinged with the lock tongue, the first spring butts between the bottom of the lock tongue cavity and the lock tongue buckle, a first stop is integrally arranged on the main lock body, and when the lock tongue is inserted into the main lock body, the lock tongue buckle protrudes from the lock tongue cavity and butts against the first stop under the elastic force of the first spring.

3. The tie padlock according to claim 2, wherein the unlocking mechanism includes an unlock button, a middle part of the unlock button is fixedly connected or hinged with the main lock body, and two ends of the unlock button are respectively opposite to the lock tongue buckles at left and right corresponding ends.

4. The tie padlock according to claim 1, wherein the tie locking mechanism includes a second spring and two tie locking blocks, the main lock body is internally provided with a locking block cavity, the locking block cavity is communicated with the tie hole when the lock tongue is inserted into the main lock body, the tie locking block is arranged in the locking block cavity, the second spring butts between the two tie locking blocks, a second stop for preventing the tie locking block from bouncing off the locking block cavity is arranged in the locking block cavity, retaining clamping teeth are integrally arranged at one end of the tie locking block towards the tie, a plurality of retaining slots arrayed along a length direction are integrally arranged at one side of the tie passing through the tie hole towards the tie locking block, and the retaining clamping teeth are clamped into the retaining slots.

5. The tie padlock according to claim 1, wherein two vertically symmetrical lock tongues are integrally arranged on the tie lock body, the tie locking mechanism is located between the upper and lower lock tongues, and unlocking mechanisms corresponding to the upper and lower lock tongues are respectively arranged at upper and lower ends of the main lock body.

6. The tie padlock according to claim 1, wherein a knob or button is arranged on a front face of the main lock body.
